(19) United States
(12) Patent Application Publication
(10) Pub. No.: US 2003/0079558 A1
(43) Pub. Date: May 1, 2003

(54) Model engine interlock end start converter

(76) Inventor: Brian G. Muehlbauer, Orlando, FL (US)

Correspondence Address: Edward M. Livingston, Esq., 628 Ellen Dr., P.O. Box 1599, Winter Park, FL, 32790, US

(21) Appl. No.: 09/983,955

(22) Filed: Oct. 25, 2001

(51) Int. Cl. F02N 11/00

(52) U.S. Cl. 74/6

(57) ABSTRACT

A model engine interlock-end start converter has a replacement start shaft (1), a converter sleeve (2) and a converter ring (3) to replace a pull-start shaft (23) on a conversional model engine (15) that includes the PICCO®, NOVAROSSI® and HPI EVOLUTION II® model engines and to position interlock shoulders that include a hexagonal head (16) of the replacement start shaft for interlock-coupling communication with a desired electric starter (18) that includes a Traxxas® EZ Start System. The converter is made available in a converter package (6) for handling and for merchandising. The converter package contains assembly instructions (5) for replacing a pull starter (22) of the PICCO®, NOVAROSSI® and HPI EVOLUTION II® model engines with an EZ® electric starter for use on model race cars that include the Traxxas® model truck (21).

### BACKGROUND OF THE INVENTION

This invention relates to converting from a pull starter to an electric starter on model engines having an interlock end of a start shaft for use primarily on model cars which are known also as model trucks and model racers.

Remote-controlled model cars and trucks that resemble miniature all-terrain vehicles and trade-known as trucks or racers are popular worldwide. The model cars, trucks and racers, referred to hereafter as model trucks, are about eighteen inches long, fourteen inches wide, seven inches high and have high-traction tires with a diameter of about six inches. Mobile power and control are provided by model engines and remote control similar to model airplanes.

Some of the more popular model trucks have electric starters on model engines that are not as powerful and preferred as widely by their owners as a selection of more powerful model engines that are being produced to satisfy market demand of enthusiastic owners for more model-engine power. The more powerful model engines fit onto the more popular model trucks, but have pull starters that are less desirable and cannot use the electric starter that is produced for and that is marketed as a component of some of the more popular model trucks.

Some of the model engines that are more powerful than a model engine used on model trucks are used on model airplanes, but without the desirable electric starter used on some of the popular model trucks.

This invention makes it possible for a particular class or structure of the more powerful model engines not only to use the electric starters of the more popular model trucks, but also to fit onto some of the more popular model trucks with a popular electric starter attached. The particular class or structure of the model engines to which this invention applies have a start shaft with interlock shoulders on a starter end and a one-way-clutch axle on a crankshaft end. The one-way-clutch axle fits into an internal one-way clutch having a crank plate on a crankshaft end.

This class of model engines is distinguished from a class of model engines having a start shaft with an axle for an external one-way clutch on a starter end and a crank plate that is part of a split crankshaft on a crankshaft end.

There is no known adaptor for converting from pull start to electric start of model engines in a manner taught by this invention and, therefore, none provided as a converter package taught by this invention.

Examples of most-closely related known but different devices are described in the following patent documents:

| U.S. Pat. No. | Inventor | Issue Date |
|---|---|---|
| 5,765,438 | Chang | Jun. 16, 1998 |
| 3,321,985 | Wheeler | May 30, 1967 |
| 2,939,448 | Hansen | Jun. 7, 1960 |
| 2,553,930 | Moody | May 22, 1951 |
| 4,274,292 | Arnett, Jr. | Jun, 23, 1981 |

### SUMMARY OF THE INVENTION

Objects of patentable novelty and utility taught by this invention are to provide a model engine interlock-end start converter which:

makes it possible to use model-engine electric starters of a class that includes a Traxxas® electric starter with an EZ® Start System for starting a class of model engines that includes a PICCO®, a NOVAROSSI® and an HPI EVOLUTION II® model engine;

makes it possible to use PICCO®, NOVAROSSI® and HPI EVOLUTION II® and others of the same class of model engines having Traxxas® electric starters on Traxxas® model trucks and racers;

is quick and easy to install;

contains descriptive and illustrative assembly instructions; and

can be made available in a kit for convenient purchase and use.

This invention accomplishes these and other objectives with a model engine interlock-end start converter having a replacement start shaft and a converter sleeve to replace a pull-start shaft on a conversional model engine that includes the PICCO®, NOVAROSSI® and HPI EVOLUTION II® model engines and to position interlock shoulders of the replacement start shaft for interlock-coupling communication with a predetermined electric starter that includes a Traxxas® EZ Start System. It is made available in a converter package for handling and for merchandising. The converter package contains assembly instructions for replacing the pull starter of the PICCO®, NOVAROSSI® and HPI EVOLUTION II® model engines with an EZ® electric starter for use on model race cars that include the Traxxas® model truck.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a front elevation view of a converter package for containing a model-engine interlock-end start converter;

FIG. 2 is a representation of a set of assembly instructions;

FIG. 3 is a side view of a replacement start shaft;

FIG. 4 is an end view of an converter sleeve;

FIG. 5 is a side view of the converter sleeve;

FIG. 6 is an end view of a converter ring;

FIG. 7 is a side view of the converter ring;

FIG. 8 a side view of fastener bolts for fastening an electric starter which can include the Traxxas® electric starter onto a conversional model engines, which include the PICCO®, NOVAROSSI® and HPI EVOLUTION II® model engines and other model engines of the same class;

FIG. 9 is a partially cutaway side view of a conversional model engine having a pull starter attached;

FIG. 10 is a crankshaft-end view of a pull-start shaft of a conversional model engine;

FIG. 11 is a partially cutaway side view of the conversional model engine from which the pull starter and the pull-start shaft have been removed for replacement with the replacement start shaft;

FIG. 12 is a crankshaft-end view of the replacement start shaft;

FIG. 13 is a partially cutaway side view of the conversional model engine into which the replacement start shaft has been inserted;

FIG. 14 is the FIG. 13 illustration with the converter sleeve and the converter ring in line to be positioned on the conversional model engine;

FIG. 15 is a front view of the conversional model engine onto which the converter sleeve and the converter ring are positioned preparatory to positioning of the electric starter;

FIG. 16 is a partially cutaway side view of the conversional model engine into which the replacement start shaft has been inserted, onto which the converter sleeve and the converter ring are positioned and with the electric starter lined up to be attached to the conversional model engine;

FIG. 17 is a partially cutaway side view of the conversional model engine with the electric starter attached;

FIG. 18 is a front view of the conversional model engine with the electric starter attached; and

FIG. 19 is a top view of the conversional model engine mounted on a popular model truck which includes the Traxxas® model truck.

### DESCRIPTION OF PREFERRED EMBODIMENT

Listed numerically below with reference to the drawings are terms used to describe features of this invention. These terms and numbers assigned to them designate the same features throughout this description.

1. Replacement start shaft
2. Converter sleeve
3. Converter ring
4. Converter fasteners
5. Assembly instructions
6. Converter package
7. Clutch portion
8. One-way clutching members
9. Inside one-way clutch
10, Rear adaptor
11. Crank plate
12. Crank axle
13. Connecting rod
14. Piston
15. Conversional model engine
16. Hexagonal head
17. Rotational coupling
18. Electric starter
19. Split crankshaft
20. Adaptor plate
21. Traxxas ® model truck
22. Pull starter
23. Pull-start shaft
24. Pull-start hex
25. Bearing housing
26. Shaft bearing
27. Closure seal
28. Attachment orifices

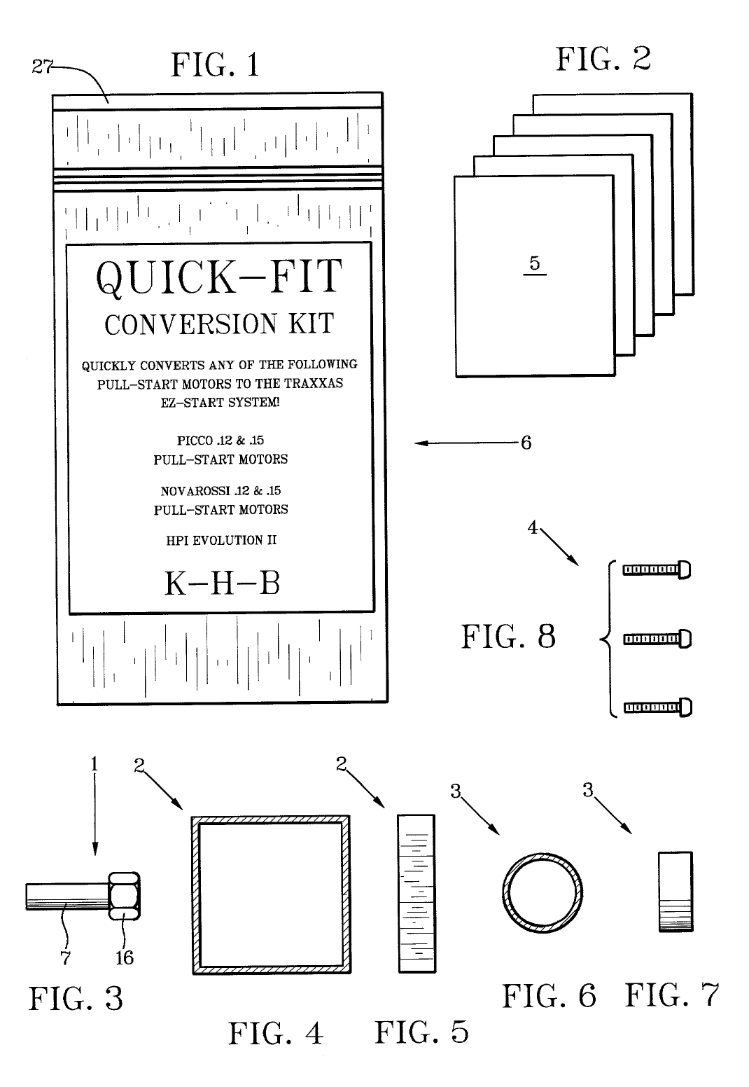

Referring to FIGS. 1-8, the model-engine interlock-end start converter includes a replacement start shaft 1, a converter sleeve 2, a converter ring 3, converter fasteners 4, and assembly instructions 5 that can be contained in a converter package 6 for pre-assembly handling and for commercial distribution.

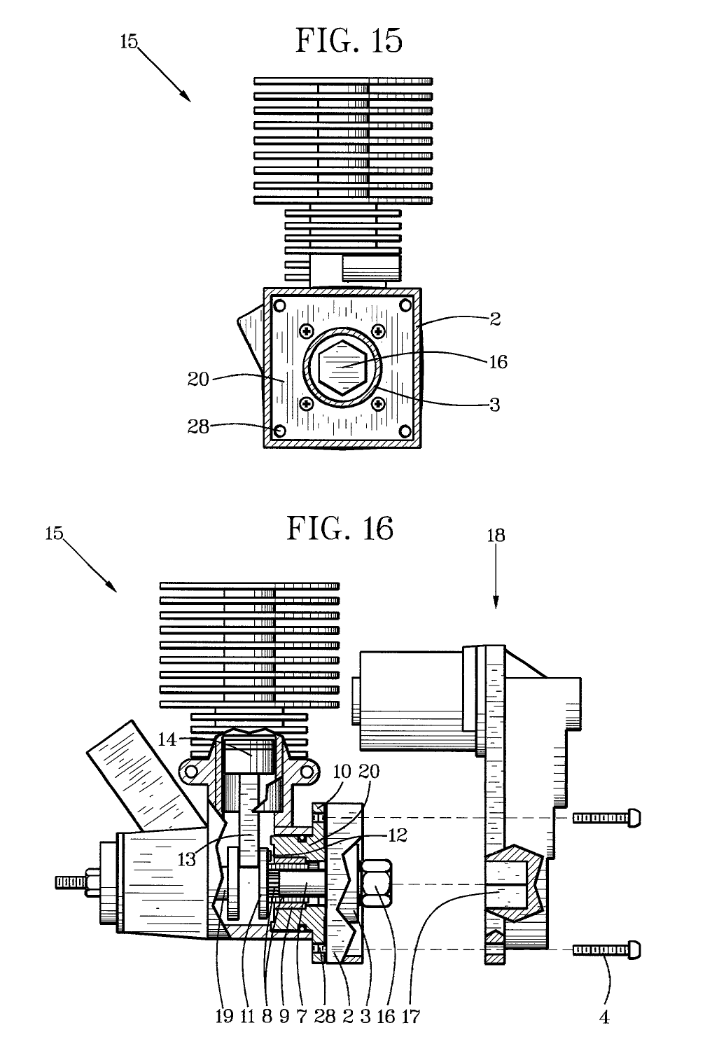

Referring to FIGS. 1-16, the replacement start shaft 1 has a clutch portion 7 that is cylindrical with an outside periphery articulated for engagement by one-way clutching members 8 proximate an inside periphery of an inside one-way clutch 9.

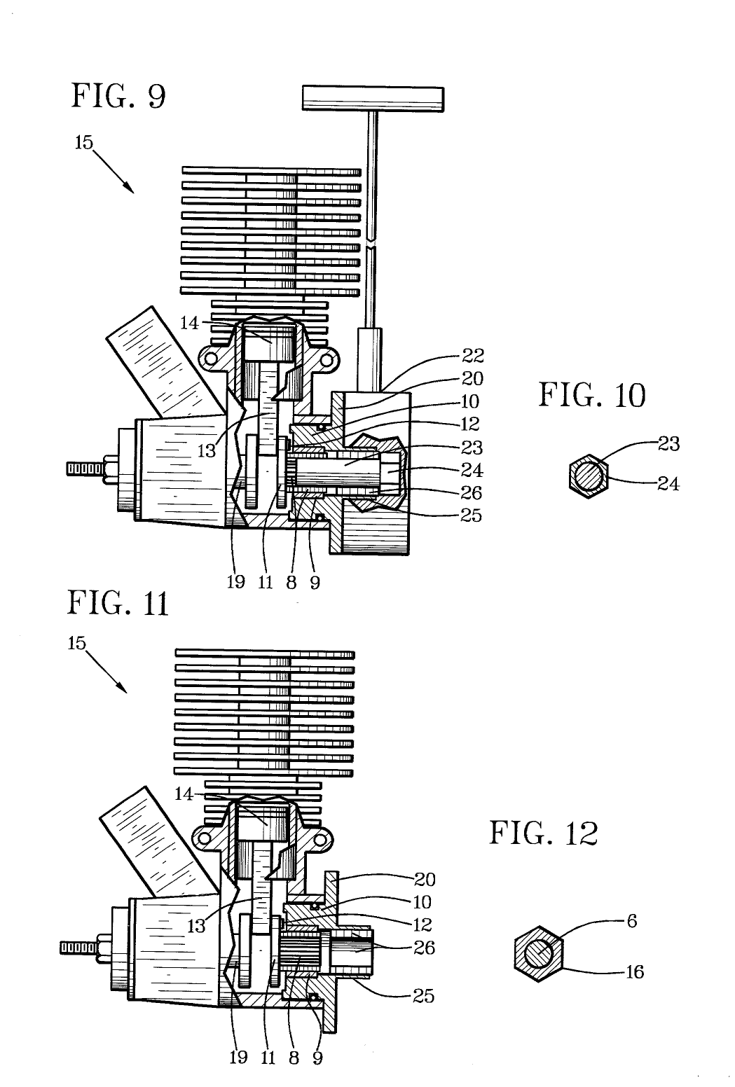

As shown in FIGS. 9-14 and 16-17, the inside one-way clutch 9 has an outside periphery in rotational contact with an inside periphery of a rear adaptor 10 and has a crank plate 11 on a crankshaft end in rotational contact with a crank axle 12 to which a connecting rod 13 of a piston 14 is connected pivotally in a conversional model engine 15.

The conversional model engine 15 includes a class of model engines with trade names of PICCO®, NOVAROSSI® and HPI EVOLUTION II® in addition to other model engines of a same class. This class of model engines is characterized by the inside one-way clutch 9 that has an outside periphery in rotational contact with an inside periphery of a rear adaptor 10 and has a crank plate 11 on a crankshaft end with a crank axle 12 to which a connecting rod 13 of a piston 14 is connected pivotally in a conversional model engine 15. This class of model engines is distinguished from a class of model engines that include an O.S.® Model engine having a start shaft with an axle on a starter end articulated for an external one-way clutch and having a crank plate that is part of a split crankshaft on a crankshaft end.

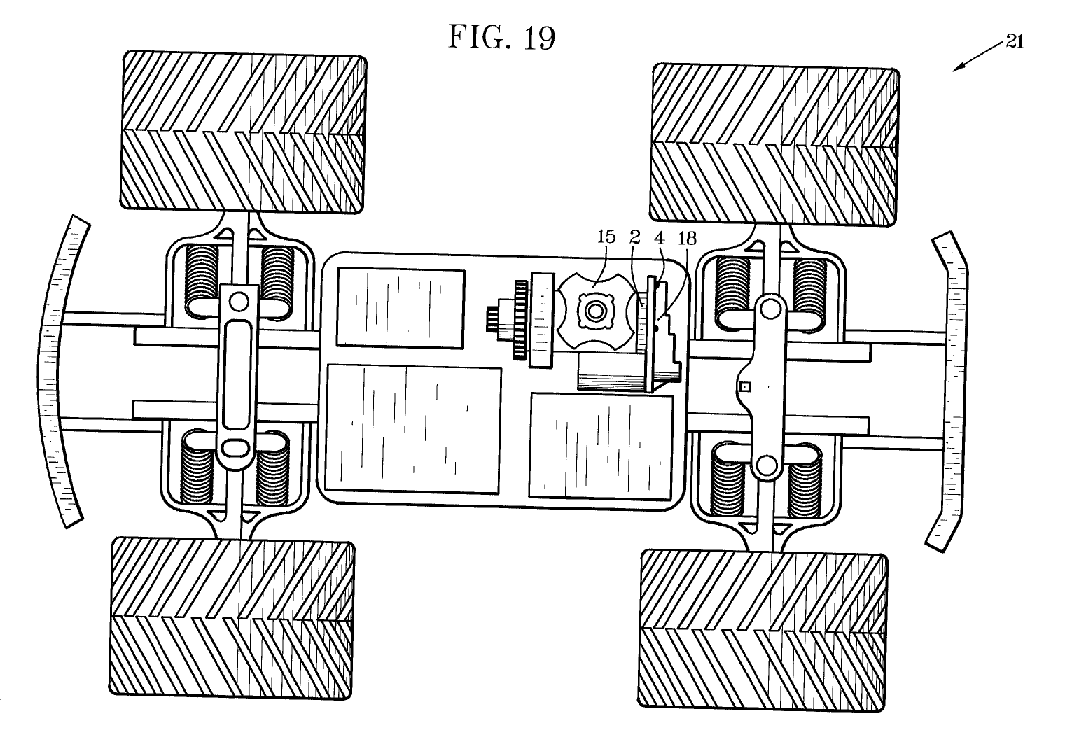

Split crankshafts 19, shown in FIGS. 9, 11, 13-14 and 16-18, with the crank plate 11 and the crank axle 12 are conventional in model engines for facilitating assembly of small parts. Differences in two classes of model engines are inside positioning of a one-way clutch in the class of engines for which this invention is intended and outside positioning of the one-way clutch of a second class for engagement with recoil and electric starters.

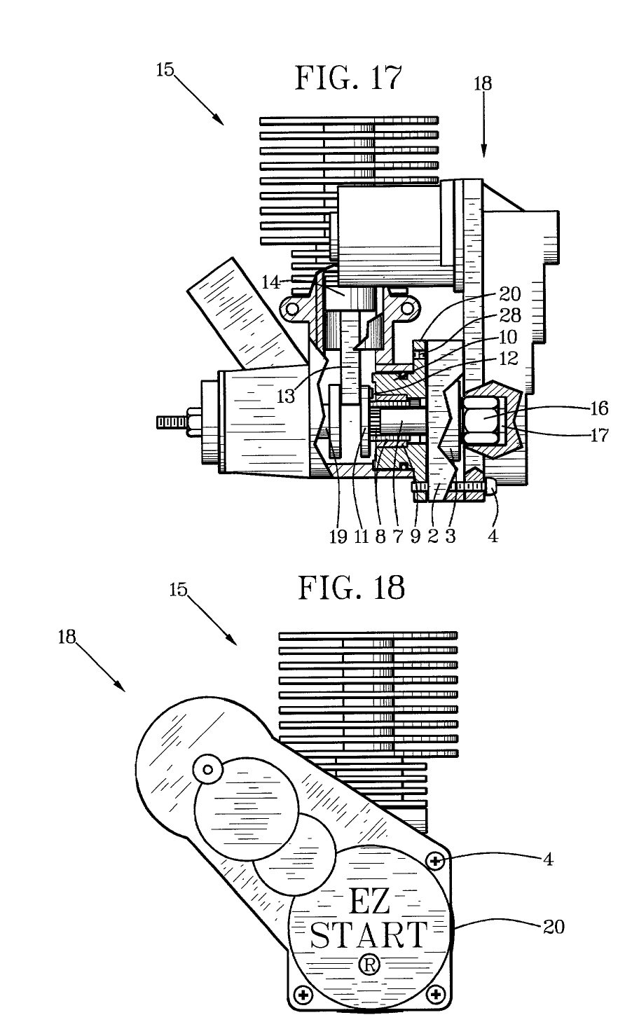

The replacement start shaft 1 has an interlock end with interlock members that include dihedral angles between flats of a hexagonal head 16 shown in FIGS. 1, 12-14 and 16-17, that is articulated to interlock with a rotational coupling 17 shown in FIGS. 16-17 of an electric starter 18 shown in FIGS. 16-19.

The converter sleeve 2 is articulated to position the electric starter 18 in predetermined proximity to an adaptor plate 20 of the rear adaptor 10 of the conversional model engine 15 for interlocking contact of the interlock members on the hexagonal head 16 with the rotational coupling 17 of the electric starter 18.

The electric starter 18 is fastened to the rear adaptor 10, preferably to the adaptor plate 20, with the converter fasteners 4 that are sized appropriately.

The electric starter 18 is preferably a Traxxas® electric starter. Although the conversional model engine 15 with the electric starter 18 attached can be used on most model cars, it is shown on a Traxxas® model truck 21 in FIG. 19.

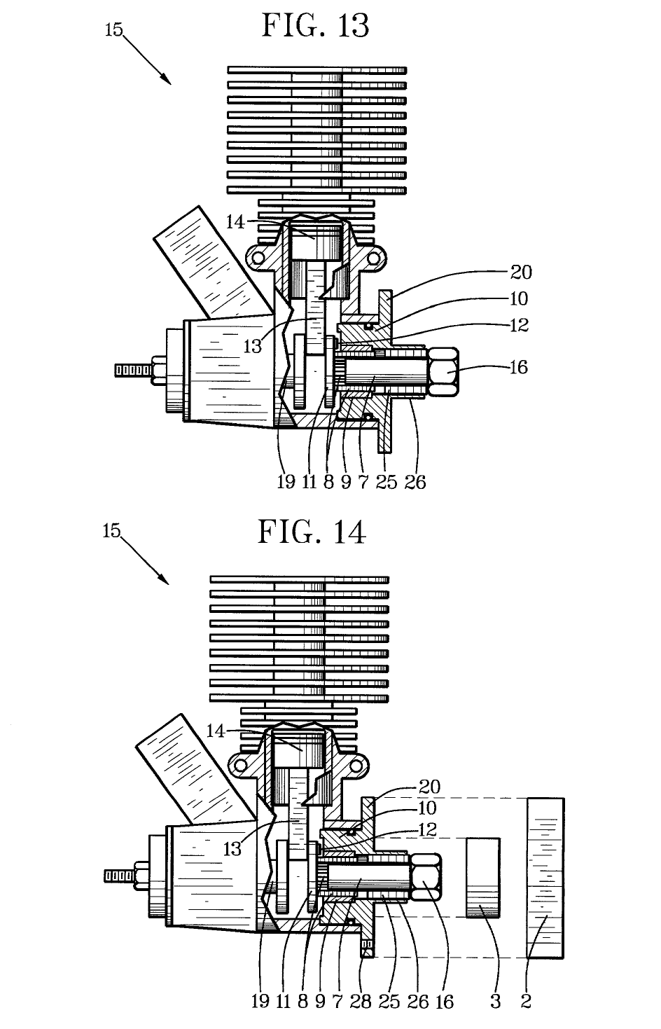

As shown in FIGS. 9-10, the conversional model engine 15 has a pull starter 22 with a pull-start shaft 23 having a pull-start hex 24 that does not fit into the rotational coupling 17 of the electric starter 18. These must be removed as shown in FIG. 11 before the replacement start shaft 1 can be inserted as shown in FIG. 13 and positioned with the converter sleeve 2 as shown progressively in FIGS. 14-18.

The converter ring 3 can be used in addition to the converter sleeve 2 as shown in FIGS. 14-17 for rigidity, for optional engagement with an outside periphery of a bearing housing 25 and contaminant protection of a shaft bearing 26 in the bearing housing 25 of the rear adaptor 10. Low-weight rigidity and bearing protection in addition to predetermined positioning of the electric starter 18 are provided with the converter sleeve 2 and the converter ring 3.

For sales and for pre-assembly handling, the converter package 6 is preferably a see-through plastic container that is reclosable and has a closure seal 27 for indicating prior opening.

The assembly instructions preferably contain an explanation for removal of the pull-starter 22 and the pull-start shaft 23 from the conversional model engine 15 for replacement by the replacement start shaft 1 and attachment of the electric starter 18 with appropriate spacing and positioning by the converter sleeve 2 and the converter ring 3 for fastening with the converter fasteners 4.

For use of this invention on the conversional model engine 15 that includes 10 model engines having trade names of PICCO®, NOVAROSSI® and HPI EVOLUTION II®: the cylindrical clutch portion 7 has a diameter of predeterminedly proximate six millimeters and a length of predeterminedly proximate twenty millimeters; the hexagonal head 16 has an external periphery with predeterminedly proximate eleven millimeters diametrically across the flats; the hexagonal head 16 has a length of predeterminedly proximate seven millimeters; the converter sleeve 2 has an external periphery that is predeterminedly square with predeterminedly proximate thirty-eight-millimeter sides, a wall thickness of predeterminedly proximate one and one-half millimeters and a length of predeterminedly proximate nine millimeters; the converter ring 3 has an external periphery that is predeterminedly round with an outside diameter of predeterminedly proximate nineteen millimeters, a wall thickness of predeterminedly proximate one and one-half millimeters and a length of predeterminedly proximate eight millimeters; and the converter fasteners 4 are threaded bolts that have a length of predeterminedly proximate sixteen millimeters with thread size and diameter of predeterminedly proximate two millimeters to match thread size and diameter of attachment orifices 28 that are threaded for attachment of the pull starter 22 prior to its removal for replacement with the electric starter 18.

Low weight of the components of this invention are critical. This can be achieved with small dimensions of high-tensile material or with larger dimensions of low-tensile materials. Titanium alloys are about half-way between the tensile strength of the best aluminum alloys and the best ferrous alloys. Selection involves economic considerations. Ideally except for economic considerations, the highest-tensile ferrous alloys are stronger per weight, more durable and corrosion resistant.

A new and useful model engine interlock-end start converter having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A model-engine interlock-end start converter comprising:
a converter combination;
the converter combination including a replacement start shaft and a converter sleeve;
the replacement start shaft having a clutch portion that is cylindrical with an outside periphery articulated for engagement by one-way clutching members proximate an inside periphery of an inside one-way clutch of a conversional model engine;
the inside one-way clutch having an outside periphery in rotational contact with an inside periphery of a rear adaptor of the conversional model engine and having a crank plate on a crankshaft end in rotational contact with a crank axle of a split crankshaft to which a connecting rod of a piston is connected pivotally in the conversional model engine;
the replacement start shaft having an interlock end with interlock members articulated to interlock with a rotational coupling of a predetermined electric starter for a model engine;
the converter sleeve being articulated to position the electric starter in predetermined proximity to the rear adaptor for interlocking contact of the interlock members and the rotational coupling; and
the electric starter is fastened to the rear adaptor with converter fasteners.

2. The model-engine interlock-end converter of claim 1 wherein:
the converter sleeve is light with thin walls proximate an outside periphery of a rear-adaptor plate predeterminedly.

3. The model-engine interlock-end converter of claim 1 and further comprising:
a converter ring positioned circumferentially internal from the converter sleeve and extended intermediate the rear-adaptor plate and the electric starter.

4. The model-engine interlock-end converter of claim 1 and further comprising:
a converter fasteners articulated to fasten the electric starter to the rear-adaptor plate and to maintain the converter sleeve intermediate the electric starter and the rear-adaptor plate.

5. A model-engine interlock-end start converter comprising:
a converter package;
the converter package containing a replacement start shaft, a converter ring, fasteners and assembly instructions;
the replacement start shaft having a clutch portion that is cylindrical with an outside periphery articulated for engagement by one-way clutching members proximate an inside periphery of an inside one-way clutch;
the conversional engine including PICCO®, NOVAROSSI® and HPI EVOLUTION II® and other model engines of a same class;
the inside one-way clutch having an outside periphery in rotational contact with an inside periphery of a rear adaptor and having a crank plate on a crankshaft end in rotational contact with a crank axle to which a connecting rod of a piston is connected pivotally in the conversional model engine;
the converter sleeve being articulated to position a Traxxas® electric starter on the conversional model engine; and
the fasteners being attachment bolts having lengths and machine threads for fastening the electric starter to the rear-adaptor plate.

6. The model-engine interlock-end start converter of claim 5 wherein:
the assembly instructions contain an explanation for removal of a pull-start shaft from the conversional model engine and for replacement of the pull-start shaft with the replacement start shaft.

7. The model-engine interlock-end start converter of claim 5 wherein:
the assembly instructions contain an explanation for attaching the Traxxas® electric starter to the conversional model engine which contains the replacement start shaft.

8. The model-engine interlock-end start converter of claim 5 wherein:
the converter package is a see-through plastic container that is reclosable.

9. The model-engine interlock-end start converter of claim 8 and further comprising:
the converter package includes a closure seal for indicating prior opening of the converter package that has been opened.

10. A model-engine interlock-end start converter comprising:
a replacement start shaft, a converter sleeve, a converter ring and converter fasteners;
the replacement start shaft having a clutch portion that is cylindrical with an outside periphery articulated for engagement by one-way clutching members proximate an inside periphery of an inside one-way clutch of a conversional model engine;
the inside one-way clutch having an outside periphery in rotational contact with an inside periphery of a rear adaptor of the conversional model engine and having a crank plate on a crankshaft end in rotational contact with a crank axle of a split crankshaft to which a connecting rod of a piston is connected pivotally in the conversional model engine;
the replacement start shaft having an interlock end with interlock members articulated to interlock with a rotational coupling of a predetermined electric starter for a model engine;
the converter sleeve being articulated to position the electric starter in predetermined proximity to the rear adaptor for interlocking contact of the interlock members and the rotational coupling;
the electric starter is fastened to the rear adaptor with the converter fasteners;
the converter sleeve is light with thin walls proximate an outside periphery of a rear-adaptor plate on the rear adaptor predeterminedly;
the converter ring is positioned circumferentially internal from the converter sleeve and extended intermediate the rear-adaptor plate and the electric starter; and
the converter fasteners are articulated to fasten the electric starter to the rear-adaptor plate and to maintain the converter sleeve and the converter ring intermediate the electric starter and the rear-adaptor plate.

11. The model-engine interlock-end converter of claim 10 wherein:
the conversional engine includes model engines having trade names of PICCO®, NOVAROSSI® and HPI EVOLUTION II® and other model engines of a same class that is distinguished by having an internal one-way clutch; and
the inside one-way clutch having an outside periphery in rotational contact with an inside periphery of the rear adaptor and having a crank plate on a crankshaft end in rotational contact with a crank axle to which a connecting rod of a piston is connected pivotally in the conversional model engine.

12. The model-engine interlock-end converter of claim 10 wherein:
the replacement start shaft includes a cylindrical portion and an interlock portion;
the cylindrical portion is articulated for clutch engagement by one-way clutching members proximate an inside periphery of the inside one-way clutch; and
the interlock portion is articulated for coupling engagement by a rotational coupling of the electric starter.

13. The model-engine interlock-end converter of claim 12 wherein:
the interlock portion is a hexagonal head with hexagonal flats between dihedral angles being interlock members.

14. The model-engine interlock-end converter of claim 12 wherein:
the cylindrical portion has a diameter of predeterminedly proximate six millimeters and a length of predeterminedly proximate twenty millimeters.

15. The model-engine interlock-end converter of claim 13 wherein:
the hexagonal head has an external periphery with predeterminedly proximate eleven millimeters diametrically across the hexagonal flats.

16. The model-engine interlock-end converter of claim 13 wherein:
the hexagonal head has a length of predeterminedly proximate seven millimeters.

17. The model-engine interlock-end converter of claim 10 wherein:
the converter sleeve has an external periphery that is predeterminedly square with predeterminedly proximate thirty-eight-millimeter sides, a wall thickness of predeterminedly proximate one and one-half millimeters and a length of predeterminedly proximate nine millimeters.

18. The model-engine interlock-end converter of claim 10 wherein:
the converter ring has an external periphery that is predeterminedly round with an outside diameter of predeterminedly proximate nineteen millimeters, a wall thickness of predeterminedly proximate one and one-half millimeters and a length of predeterminedly proximate eight millimeters.

19. The model-engine interlock-end converter of claim 10 wherein:
the converter fasteners are threaded bolts that have a length of predeterminedly proximate sixteen millimeters with thread size and diameter of predeterminedly proximate two millimeters to match thread size and diameter of attachment orifices that are threaded for attachment of the pull starter prior to its removal for replacement with the electric starter.

20. The model-engine interlock-end converter of claim 10 wherein:
the conversional engine includes model engines having trade names of PICCO®, NOVAROSSI® and HPI EVOLUTION II® and other model engines of a same class that is distinguished by having an internal one-way clutch;
the inside one-way clutch having an outside periphery in rotational contact with an inside periphery of a rear adaptor and having a crank plate on a crankshaft end in rotational contact with a crank axle to which a connecting rod of a piston is connected pivotally in the conversional model engine;
the replacement start shaft includes a cylindrical portion and an interlock portion;
the cylindrical portion is articulated for clutch engagement by one-way clutching members proximate an inside periphery of the inside one-way clutch;
the interlock portion is articulated for coupling engagement by a rotational coupling of the electric starter;
the interlock portion is a hexagonal head with hexagonal flats between dihedral angles being interlock members;
the cylindrical portion has a diameter of predeterminedly proximate six millimeters and a length of predeterminedly proximate twenty millimeters;
the hexagonal head has an external periphery with predeterminedly proximate eleven millimeters diametrically across the hexagonal flats;
the hexagonal head has a length of predeterminedly proximate seven millimeters;
the converter sleeve has an external periphery that is predeterminedly square with predeterminedly proximate thirty-eight-millimeter sides, a wall thickness of predeterminedly proximate one and one-half millimeters and a length of predeterminedly proximate nine millimeters;
the converter ring has an external periphery that is predeterminedly round with an outside diameter of predeterminedly proximate nineteen millimeters, a wall thickness of predeterminedly proximate one and one-half millimeters and a length of predeterminedly proximate eight millimeters; and
the converter fasteners are threaded bolts that have a length of predeterminedly proximate sixteen millimeters with thread size and diameter of predeterminedly proximate two millimeters to match thread size and diameter of attachment orifices that are threaded for attachment of the pull starter prior to its removal for replacement with the electric starter.
